(19) United States
(12) Patent Application Publication
(10) Pub. No.: US 2009/0178509 A1
(43) Pub. Date: Jul. 16, 2009

(54) Steering wheel

(75) Inventor: Frank Seidl, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 12/314,593

(22) Filed: Dec. 12, 2008

(30) Foreign Application Priority Data
Jan. 16, 2008 (JP) 2008-007329

(51) Int. Cl. B62D 1/06; B62D 1/04

(52) U.S. Cl. 74/558; 74/552

(57) ABSTRACT

A wrapped steering wheel in which a coating layer that has coated a cored bar of a gripping portion is wrapped with a covering, and both end portions of the covering are combined upon confronting on an inner peripheral surface side of the coating layer. The confronted both end portions are stitched together in such a way that seams of a thread that are in parallel with a confronting portion of both end portions are arranged in a manner so as to face each other at the confronted both end portions on a front side of the covering, and that seams of the thread crossing the front side seams are arranged at the confronted both end portions on a backside of the covering.

### BACKGROUND

The present application relates to a covered steering wheel in which a gripping portion of a steering wheel is covered. The covering may be natural leather (e.g., the processed skin of an animal), but also artificial leather, a fur skin, or cloth.

Steering wheels are known to include a coating surrounding a rigid core (e.g., a bar) and a gripping portion that is wrapped with a covering, such as leather. In a leather-wrapped steering wheel, the leather is attached to the gripping portion by handstitching individual end portions in a coating layer-peripheral direction of the wrapped leather upon confronting with each other, or by means of bonding the leather to the covering layer upon applying an adhesive agent.

When an adhesive is used to attach the leather to the gripping portion, the leather may shrink due to a variation of a thermal load of a temperature in a vehicle interior, causing the end portions of the confronted leather to be separated from each other. It has been proposed to form a concave groove on an inner peripheral surface of the coating layer of the gripping portion in a peripheral direction of the steering wheel. The adhesive agent is applied to the concave groove forming an adhesive agent pool into which the end portions of the leather may be adhered.

According to the above-proposed technology, a bonding strength of both end portions of the leather is improved because both end portions of the leather are bonded to the coating layer of the gripping portion and the amount of the adhesive agent (e.g., forming the adhesive agent pool portion) is increased. However, since both end portions of the leather are bonded with the adhesive agent, the end portions of the leather can not be combined by a stitching.

### SUMMARY

One disclosed embodiment relates to a wrapped steering wheel in which a coating layer that has coated a cored bar of a gripping portion is wrapped with a covering, and both end portions of the covering are combined upon confronting on an inner peripheral surface side of the coating layer. The confronted both end portions are stitched together in such a way that seams of a thread that are in parallel with a confronting portion of both end portions are arranged in a manner so as to face each other at the confronted both end portions on a front side of the covering, and that seams of the thread crossing the front side seams are arranged at the confronted both end portions on a backside of the covering.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a partially broken front elevation illustrating a wrapped steering wheel according to an embodiment of the present invention.

FIG. 2 is a lateral cross-sectional view illustrating the wrapped steering wheel of FIG. 1.

FIG. 3 is a front elevation illustrating a gripping portion of the wrapped steering wheel of FIG. 1, looking from an inner periphery side.

FIG. 4 is a perspective view illustrating a combining method for combining end portions of the covering for the steering wheel of FIG. 1.

FIG. 5 is a front elevation illustrating a wrapped steering wheel according to another embodiment of the present invention, looking from an inner periphery side of a gripping portion.

FIG. 6 is a perspective view illustrating a combining method for combining end portions of the covering of the wrapped steering wheel of FIG. 5.

FIG. 7 is a lateral cross-sectional view illustrating a variation of a structure of both end portions of the covering

### DETAILED DESCRIPTION

According to one exemplary embodiment, a steering wheel comprises a coating layer that has coated a cored bar of a gripping portion and is wrapped with a covering such as, for example, a natural or artificial leather. Both end portions of the covering are combined upon confronting on an inner peripheral surface side of the coating layer. The confronted both end portions are stitched together with seams. Seams of a thread that are parallel to a confronting portion of the end portions are facing each other at the confronted end portions on a front side of the covering. Seams of the thread crossing the front side seams are arranged at the confronted both end portions on a backside of the covering. Such a seam is relatively simple that has a pleasing aesthetic appearance.

According to one exemplary embodiment, the front side seam is formed one in number with a first thread at the first end portion and a second thread on the second end portion. The first thread runs parallel to the confronting edge of the first end portion on the front side and is inserted toward the backside. The backside seam is formed one in number with the first thread by a portion of the first thread extending from the first end portion to the second end portion and generally perpendicular to the confronting edges of the end portions. The first thread is pulled out toward the front side of the second end portion. The front side seam is thereafter further formed one in number with the first thread at the other end portion by inserting the first thread back toward the backside to form a portion parallel to the confronting edge of the second end portion.

The front side seam is formed one in number with a second thread at the first end portion and a second thread on the second end portion. The second thread runs parallel to the confronting edge of the first end portion on the front side from a position corresponding to a leader of the front side seam formed of the first thread at the one end portion to a position corresponding to a dead end thereof, over the front side of the other end portion. The second thread is inserted toward the backside of the second end portion. The backside seam is formed one in number with the second thread by a portion of the second thread extending from the second end portion to the first end portion and generally perpendicular to the confronting edges of the end portions. The second thread is pulled out toward the front side of the first end portion. The front side seam is thereafter further formed one in number with the second thread at the other end portion by inserting the second thread back toward the backside to form a portion parallel to the confronting edge of the second end portion. The parallel portion of the second thread is parallel to the confronting portion from a position corresponding to a leader of the front side seam formed of the first thread at the other end portion to a position corresponding to a dead end thereof.

The two end portions are stitched together by forming the front side seams and the backside seams with two threads at both end portions by repeating the above-described processes. Both end portions can therefore be stitched together with a simple stitching structure by forming the front side and backside seams with the two threads at the confronted both end portions of the covering.

According to another exemplary embodiment, the front side seam is formed one in number with a single thread at the first end portion and the second end portion. The thread runs parallel to the confronting edge of the first end portion on the front side and is inserted toward the backside. The backside seam is formed one in number with the thread by a portion of the thread extending from the first end portion to the second end portion and obliquely (e.g., skewed, angled) to the confronting edges of the end portions. The thread is pulled out toward the front side of the second end portion at a position corresponding to a leader of the front side seam at the other end portion in both end portions. The front side seam is thereafter further formed one in number with the thread at the other end portion by inserting the thread back toward the backside to form a portion parallel to the confronting edge of the second end portion. The thread is pulled out toward the front side of the second end portion. The front side seam is thereafter further formed one in number with the thread at the other end portion by inserting the thread back toward the backside at a position corresponding to a dead end of the front side seam at the first end portion to form a portion parallel to the confronting edge of the second end portion. The backside seam is thereafter further formed one in number with the thread by a portion of the thread extending from the second end portion to the first end portion and generally perpendicular to the confronting edges of the end portions. The thread is pulled out toward the front side of the first end portion.

The two end portions are stitched together by forming the front side seams and the backside seams with one thread at both end portions by repeating the above-described processes. Both end portions can be stitched together with a simple stitching structure by forming the front side and backside seams with one thread at the confronted both end portions of the covering.

According to various exemplary embodiments, holes facing each other for passing through the thread are provided in parallel with the confronting edges of the two end portions of the covering. Both end portions can be stitched together, by forming the front side and backside seams by easily passing the thread through the holes.

According to various exemplary embodiments, each of the holes is passed through by two threads or by the same thread twice. Therefore, the number of the holes provided at the confronted end portions of the covering can be decreased by half compared to a case in which each holes is passed through by a thread only once.

According to an exemplary embodiment, a concave groove is provided along a peripheral direction of the steering wheel on an inner peripheral surface of the coating layer. The concave groove houses the thread forming the backside seam of the covering. Since the backside seam of the covering is housed in the concave groove of the coating layer, the stitched end portions are not swollen (e.g., bulging, protruded) due to the backside seam of the covering. Instead, the stitched end portions may sit generally flush with the gripping portion of the steering wheel to provided a more aesthetically pleasing cover.

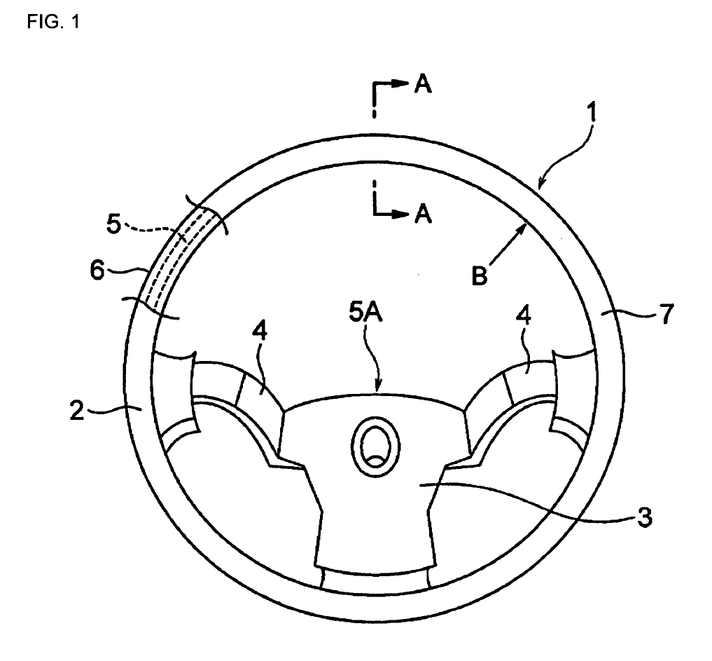

FIG. 1 is a partially broken front elevation illustrating a steering wheel according to an exemplary embodiment. In FIG. 1, a steering wheel 1 is provided with a circular ring-shaped gripping portion (rim portion) 2, a pad portion 3 disposed at a center of an inside of the gripping portion 2 in a radial direction thereof, and a core such as a bar 5A provided across spoke portions 4 in the radial direction, while connecting the gripping portion 2 and the pad portion 3. The steering wheel 1 further comprises a coating layer 6 (e.g., a resin material) on at least the bar 5 of the gripping portion 2, and a cover material or covering 7 (such as leather) around a periphery of the coating layer 6. While the cover material is described herein as a natural leather (e.g., a processed animal skin), a wide variety of materials may be used to cover the steering wheel according to other exemplary embodiments such as artificial leather, a fur skin, cloth or any other suitable flexible material.

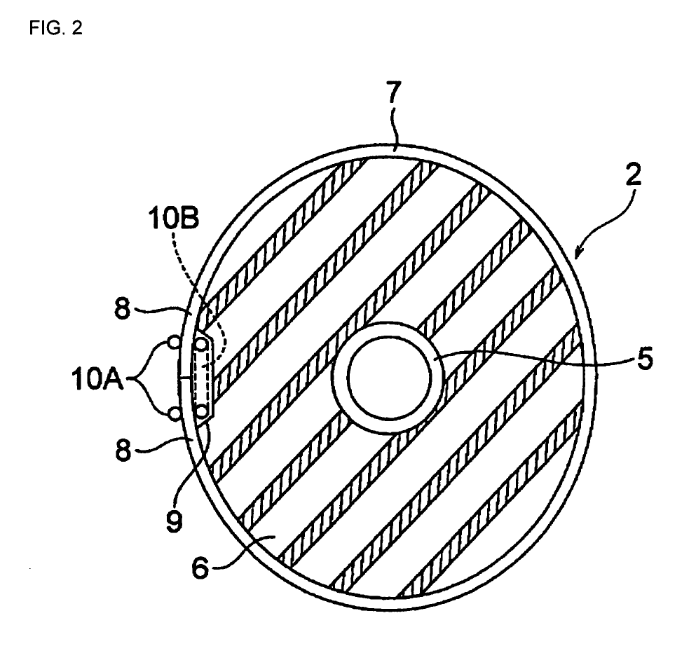

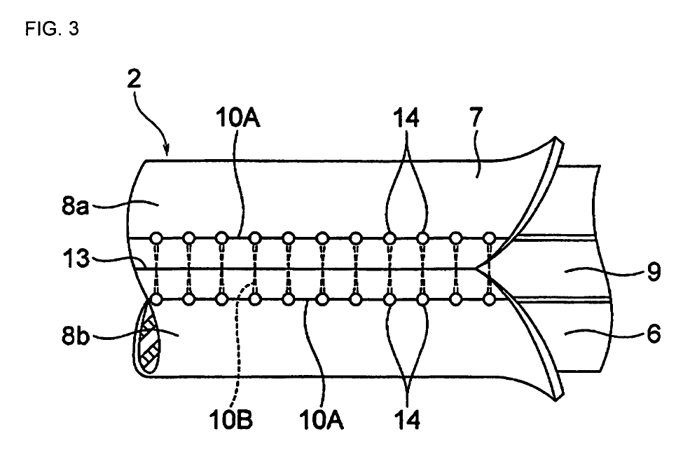

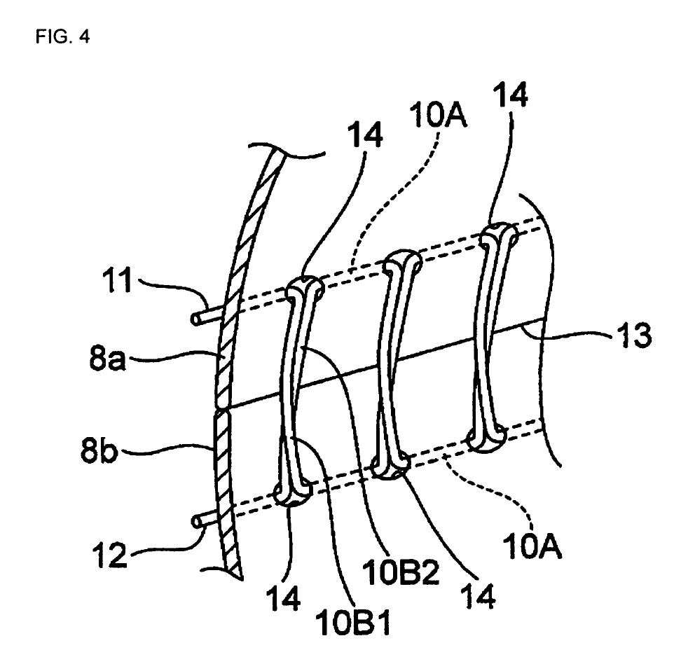

As a cross-section taken along a line A-A in FIG. 1 illustrated in FIG. 2, both end portions 8 of the leather 7 are combined in such a way that both end portions 8 are confronted on an inner peripheral surface side of the coated layer 6 of the gripping portion 2. The confronted end portions 8 are stitched together in a peripheral direction of the steering wheel 1 with a thread. A concave groove 9 is provided in the coating layer 6 that is configured to receive a backside seam 10B (refer to FIG. 3 and FIG. 4, described later) of the thread that has stitched both end portions 8 of the leather 7.

FIG. 3 is a front elevation illustrating a gripping portion of the leather-wrapped steering wheel of FIG. 1, looking from an inner periphery side as indicated by an arrow B in FIG. 1. As illustrated in FIG. 3, holes 14 through which the thread is passed (thread hole, i.e., needle hole) are provided along a confronting portion 13 in parallel therewith in a facing manner in both confronting end portions 8a and 8b of the leather 7. Further, a front side seam 10A that is in parallel with the confronting portion 13 is arranged in a facing manner on a front side of both confronting end portions 8 (8a and 8b). The backside seam 10B that crosses the front side seams 10A is arranged on the backside in a perpendicular direction to the front side seam 10A. Thus, both end portions 8 are stitched by the front side seam 10A and the backside seam 10B.

In the present embodiment, as illustrated in FIG. 4, both end portions 8 are stitched in such a way that the front side seam 10A and the backside seam 10B are formed by a first thread 11 and a second thread 12.

Firstly, a front side seam 10A is formed at the first end portion 8a on the upper side using the first thread 11. The front side seam 10A is formed by a portion of the first thread 11 extending across the front side of the first end portion 8a that is substantially parallel to the confronting portion 13. The first thread 11 is inserted through a hole 14, toward the backside from the end portion 8a. The backside seam 10B is formed by a portion of the first thread 11 extending across the back side of the first end portion 8a and the second end portion 8b that is substantially perpendicular to the confronting portion 13. The first thread 11 is pulled out toward the front side of the end portion 8b on the lower side through a hole 14. Thereby, one backside seam 10B1 that crosses both end portions 8 is formed using the first thread 11. Another front side seam 10A is formed by a portion of the first thread 11 extending across the front side of the second end portion 8b that is substantially parallel to the confronting portion 13. The first thread 11 is again inserted toward the backside through a hole 14.

A seam is formed symmetrically with respect to the first thread 11 from an end portion 8b on the lower side using the second thread 12. The front side seam 10A is formed by a portion of the second thread 12 extending across the front side of the second end portion 8b that is substantially parallel to the confronting portion 13. The second thread 12 is inserted through a hole 14, toward the backside from the end portion 8b. The front side seam 10A extends from a position0 corresponding to a leader of the front side seam 10A of the end portion 8a on the upper side formed of the first thread 11, to a position corresponding to a dead end thereof in parallel with the confronting portion 13. The backside seam 10B is formed by a portion of the second thread 12 extending across the back side of the first end portion 8a and the second end portion 8b that is substantially perpendicular to the confronting portion 13. Thereby, a backside seam 10B2 crossing both end portions 8 is formed one in number using the second thread 12, in addition to the backside seam 10B1 formed of the first thread 11. The backside seams 10B1 and 10B2 formed of the respective first and second threads 11 and 12 intersect with each other. The second thread 12 is pulled out toward the front side of the end portion 8a on the lower side through a hole 14. Thereby, one backside seam 10B1 that crosses both end portions 8 is formed using the second thread 12. Another front side seam 10A is formed by a portion of the second thread 12 extending across the front side of the first end portion 8a that is substantially parallel to the confronting portion 13. The second thread 12 is again inserted toward the backside through a hole 14. The front side seam 10A extends from a position corresponding to a leader of the front side seam 10B of the end portion 8b on the lower side formed of the first thread 11, to a position corresponding to a dead end thereof in parallel with the confronting portion 13.

The confronted both end portions 8 of the leather 7 are stitched together using two of the threads 11 and 12 by repeating the operation for forming the front side seams 10A of both end portions 8 (8a and 8b), and the backside seams 10B (10B1 and 10B2) crossing the front side seams 10A of both end portions 8 using the first and second threads 11 and 12 described above.

According to the above described embodiment, both end portions 8 are stitched together in such a way that the front side seams 10A are arranged facing each other on the front side of confronted both end portions 8 (8a and 8b) of the leather 7 in parallel with the confronting portion 13, and that the backside seams 10B (10B1 and 10B2) are arranged such that they cross the front side seams 10A, on the backside of both end portions 8 using the two threads 11 and 12. Further, the front side seams 10A that are in parallel with the confronting portion 13 are arranged on the front side of both end portions 8 of the leather 7 such that they face each other, forming an aesthetically pleasing stitch.

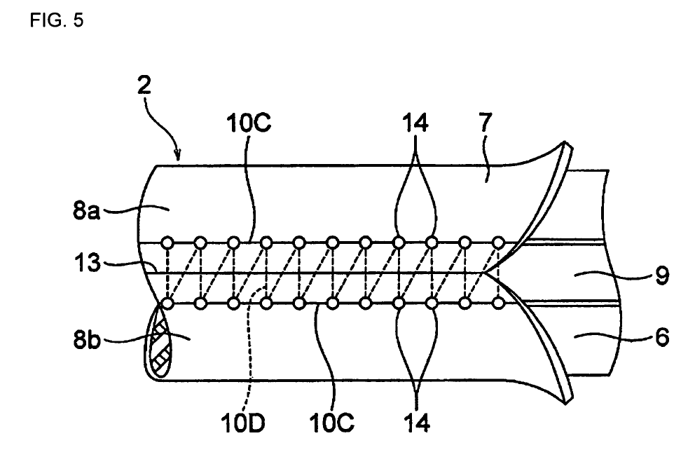

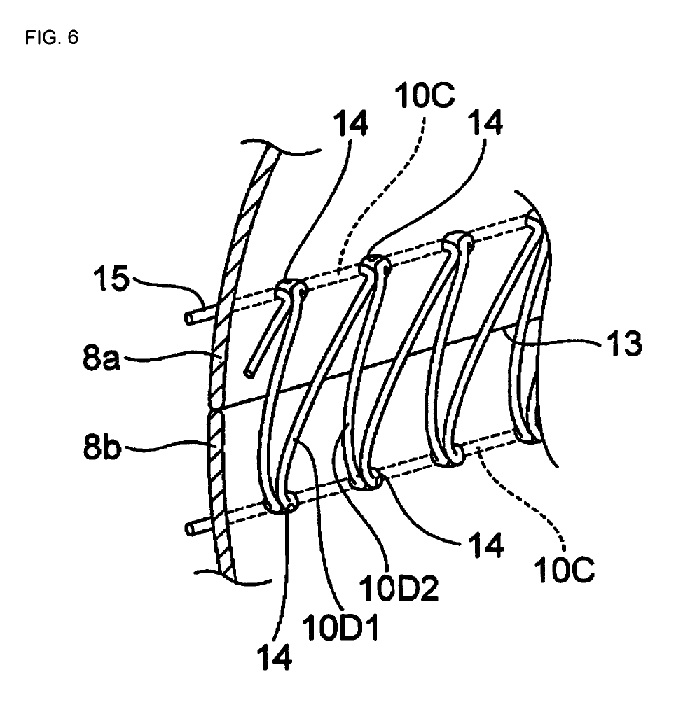

Referring now to FIGS. 5-6, another embodiment another embodiment of a steering wheel is shown. FIG. 5 is a front elevation illustrating a gripping portion of a leather-wrapped steering wheel in FIG. 1 similar to that in FIG. 1, looking from an inner periphery side. In the confronted both end portions 8a and 8b of the leather 7 of the leather-wrapped steering wheel 1, similar to the former embodiment, front side seams 10C that are in parallel with the confronting portion 13 are arranged on the front side facing each other, and backside seams 10D crossing the front side seams 10C are arranged on the backside in an oblique direction and a perpendicular direction. The end portions 8 are stitched together by the front side seams 10C and the backside seams 10D.

In the present embodiment, as illustrated in FIG. 6, both end portions 8 are stitched together by forming the front side seams 10C and the backside seams 10D by means of a single thread 15.

Firstly, a front side seam 10C is formed at the first end portion 8a on the upper side using the thread 15. The front side seam 10A is formed by a portion of the thread 15 extending across the front side of the first end portion 8a that is substantially parallel to the confronting portion 13. The thread 15 is inserted through a hole 14, toward the backside from the end portion 8a. An oblique backside seam 10D1 is formed by a portion of the thread 15 extending across the back side of the first end portion 8a and the second end portion 8b. The backside seam 10D1 extends up to a position corresponding to a leader of the front side seam 10C and is oblique (e.g., skewed, angled, etc.) to the confronting portion 13. The thread 15 is pulled out toward the front side of the end portion 8b on the lower side through a hole 14. Thereby, one backside seam 10D1 that crosses both end portions 8 is formed using the thread 15. Another front side seam 10C is formed by a portion of the thread 15 extending across the front side of the second end portion 8b that is substantially parallel to the confronting portion 13. The thread 15 is again inserted toward the backside through a hole 14. A second backside seam 10D2 is formed by a portion of the first thread 11 extending across the back side of the first end portion 8a and the second end portion 8b that is substantially perpendicular to the confronting portion 13.

By repeating a forming operation for forming the front side seams 10C of both end portions 8 (8a and 8b), and the backside seams 10D (10D1 and 10D2) crossing the front side seams 10C of both end portions 8 by means of the thread 15, described above, the confronted both end portions 8 of the leather 7 are stitched together using the one thread 15.

According to the above described embodiment, both end portions 8 are stitched together in such a way that the front side seams 10C are arranged facing each other on the front side of confronted both end portions 8 (8a and 8b) of the leather 7 in parallel with the confronting portion 13, and that the backside seams 10D (10D1 and 10D2) are arranged such that they cross the front side seams 10C, on the backside of both end portions 8 using a single threads 15. Further, the front side seams 10C that are in parallel with the confronting portion 13 are arranged on the front side of both end portions 8 of the leather 7 such that they face each other, forming an aesthetically pleasing stitch.

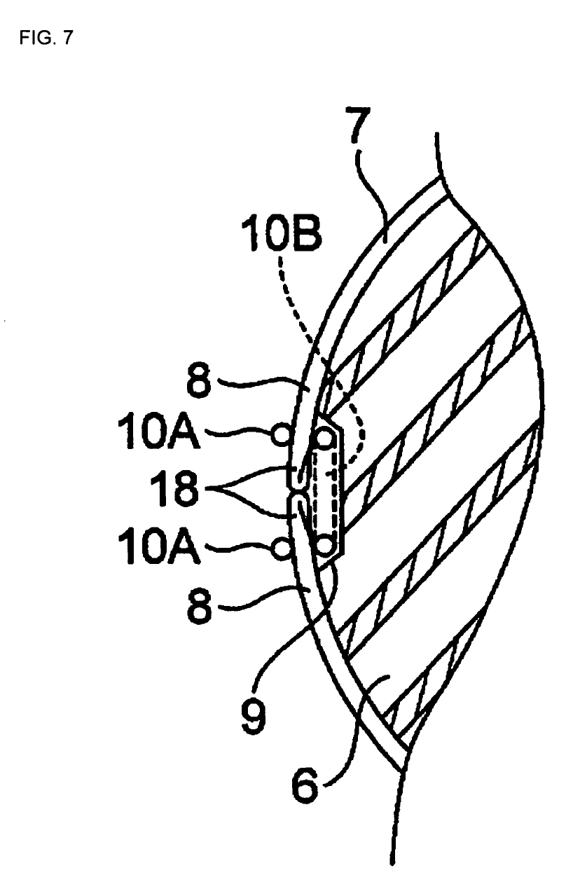

In the above-described embodiments, although confronting ends of respective both end portions 8 of the leather 7 are cut in such a way that an edge thereof is not turned up, the confronting edge is basically formed to have a cut end that is left as it is cut. However, both end portions 8 of the leather 7 are not limited thereto, and may be formed to have a structure as illustrated in FIG. 7. Both end portions 8 of the leather 7 in FIG. 7 is constructed such that a tip end side thereof is inwardly folded back, and a folded-back piece 18 is bonded to a back surface of the leather 7 with an adhesive agent. When the construction is made as described above, the confronting ends of respective both end portions 8 can be formed to have a round shape in which the edge is not turned up at all. Therefore, the confronting ends of respective both end portions 8 are highly in close contact with each other at the confronting portion 13, and appearance of stitched both end portions 8 is further improved.

The priority application, Japanese Application No. 2008-007329, filed Jan. 16, 2008, including the specification, drawings, claims, and abstract are incorporated herein by reference in its entirety.

What is claimed is:

1. A wrapped steering wheel in which a coating layer that has coated a cored bar of a gripping portion is wrapped with a covering, and both end portions of the covering are combined upon confronting on an inner peripheral surface side of the coating layer,
wherein the confronted both end portions are stitched together in such a way that seams of a thread that are in parallel with a confronting portion of both end portions are arranged in a manner so as to face each other at the confronted both end portions on a front side of the covering, and that seams of the thread crossing the front side seams are arranged at the confronted both end portions on a backside of the covering.

2. The steering wheel of claim 1,
wherein the front side seam is formed one in number with a first thread at one end portion by means of inserting the first thread toward the backside after the first thread is caused to creep in parallel with the confronting portion on the front side of one end portion in the confronted both end portions, and
wherein the backside seam is thereafter formed one in number with the first thread at both end portions by means of pulling out the first thread toward the front side of the other end portion after the first thread that is inserted toward the backside from the one end portion is caused to perpendicularly creep up to the other end portion in both end portions, and
wherein the front side seam is thereafter formed one in number with the first thread at the other end portion by means of inserting the first thread toward the backside after the first thread that is pulled out toward the front side of the other end is caused to creep in parallel with the confronting portion, and
wherein on the other hand, the front side seam is formed one in number with a second thread at the other end portion by means of inserting the second thread toward the backside after the second thread is caused to creep in parallel with the confronting portion from a position corresponding to a leader of the front side seam formed of the first thread at the one end portion to a position corresponding to a dead end thereof, over the front side of the other end portion, and wherein the backside seam is thereafter formed one in number with the second thread at both end portions by means of pulling out the second thread toward the front side after the second thread that is inserted toward the backside from the other end portion is caused to perpendicularly creep up to the one end portion, and
wherein the front side seam is thereafter formed one in number with the second thread on the front side of the one end portion by means of inserting the second thread toward the backside after the second thread that is pulled out toward the front side from the one end portion is caused to creep in parallel with the confronting portion from a position corresponding to a leader of the front side seam formed of the first thread at the other end portion to a position corresponding to a dead end thereof, and
wherein both end portions are stitched together by forming the front side seams and the backside seams with two threads at both end portions by means of repeating the above-described processes.

3. The steering wheel of claim 1,
wherein the front side seam is formed one in number with the one thread at one end portion by means of inserting the one thread toward the backside after the one thread is caused to creep in parallel with the confronting portion over the front side of the one end portion in the confronted both end portions, and
wherein the backside seam is thereafter formed one in number in an oblique manner with the one thread at both end portions by means of pulling out the one thread toward the front side after the one thread that is inserted toward the backside from the one end portion is caused to obliquely creep up to a position corresponding to a leader of the front side seam at the other end portion in both end portions, and
wherein the front side seam is thereafter formed one in number with the one thread at the other end portion by means of inserting the one thread toward the backside after the one thread that is pulled out toward the front side from the other end portion is caused to creep in parallel with the confronting portion up to a position corresponding to a dead end of the front side seam at the one end portion, and
wherein the backside seam is thereafter formed one in number in a perpendicular manner with the thread at both end portions by means of pulling out the one thread toward the front side after the one thread that is inserted toward the backside from the other end portion is caused to perpendicularly creep up to the one end portion, and
wherein both end portions are stitched together by means of forming the front side seams and the backside seams with one thread at both end portions by means of repeating the above-described processes.

4. The steering wheel of claim 3, wherein holes facing each other for passing through the thread are previously provided in parallel with the confronting portion at the confronted both end portions.

5. The steering wheel of claim 4, wherein the thread is passed through the hole for two times.

6. The steering wheel of claim 5, wherein a concave groove for housing the thread for forming the backside seam of the covering is provided along a peripheral direction of the steering wheel on an inner peripheral surface of the coating layer.

7. A steering wheel comprising a cored bar covered by a coating layer and a gripping portion including a covering wrapped around the coated core bar, wherein the covering includes two end portions extending around the rim of the steering wheel, wherein both end portions of the covering are connected on an inner peripheral surface side of the coating layer, wherein the end portions of the covering are stitched together along a boundary where the end portions of the covering confront by a first thread and a second thread, wherein the first and second threads form a pair of first seams extending parallel to the boundary and a second seam extending substantially perpendicular across the boundary, wherein the first seams are arranged on the front side of the covering, and the second seams is arranged on the backside of the covering.

8. The steering wheel of claim 7, wherein the steering wheel includes a third seam formed by the first and second threads, wherein the third seam is arranged on the backside of the covering and extends in an oblique direction relative to the boundary where the ends of the covering confront.
